(19) United States
(12) Patent Application Publication
(10) Pub. No.: US 2008/0207140 A1
(43) Pub. Date: Aug. 28, 2008

(54) Integrated circuit with contemporaneous transmission and reception of realtime and non-realtime data and methods for use therewith

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/710,747

(22) Filed: Feb. 26, 2007

(51) Int. Cl. H04B 1/02

(52) U.S. Cl. 455/91

(57) ABSTRACT

A voice data and RF integrated circuit (IC) includes an RF transmitter that generates a transmit signal contemporaneously containing both outbound realtime data and outbound non-realtime data. The integrated circuit optionally includes an RF receiver that contemporaneously generates both outbound realtime data and outbound non-realtime data from a received signal.

### CROSS-REFERENCE TO RELATED APPLICATIONS

None

### BACKGROUND OF THE INVENTION

1. Technical Field of the Invention

This invention relates generally to wireless communications systems and more particularly to radio transceivers used within such wireless communication systems.

2. Description of Related Art

Communication systems are known to support wireless and wire line communications between wireless and/or wire line communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna through an antenna interface and includes a low noise amplifier, one or more intermediate frequency stages, a filtering stage, and a data recovery stage. The low noise amplifier (LNA) receives inbound RF signals via the antenna and amplifies them. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

Many wireless communication systems include receivers and transmitters that can operate in on either realtime data or non-realtime data. Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of a wireless communication system in accordance with the present invention.

FIG. 2 is a schematic block diagram of a wireless communication device 10 in accordance with the present invention.

FIG. 3 is a schematic block diagram of an RF transceiver 125 in accordance with the present invention.

FIG. 4 is a schematic block diagram of an RF transceiver 125 in accordance with a further embodiment of the present invention.

FIG. 5 is a schematic block diagram of an embodiment of a transmitter processing module 200 in accordance with the present invention.

FIG. 6 is a schematic block diagram of an embodiment of a transmitter processing module 210 in accordance with the present invention.

FIG. 7 is a schematic block diagram of an embodiment of a transmitter processing module 220 in accordance with the present invention.

FIG. 8 is a schematic block diagram of an embodiment of a receiver processing module 230 in accordance with the present invention.

FIG. 9 is a schematic block diagram of an embodiment of a receiver processing module 240 in accordance with the present invention.

FIG. 10 is a schematic block diagram of an embodiment of a receiver processing module 250 in accordance with the present invention.

FIG. 11 is a flowchart representation of a method in accordance with an embodiment of the present invention.

FIG. 12 is a flowchart representation of a method in accordance with an embodiment of the present invention.

FIG. 13 is a flowchart representation of a method in accordance with an embodiment of the present invention.

FIG. 14 is a flowchart representation of a method in accordance with an embodiment of the present invention.

FIG. 15 is a flowchart representation of a method in accordance with an embodiment of the present invention.

FIG. 16 is a flowchart representation of a method in accordance with an embodiment of the present invention.

FIG. 17 is a flowchart representation of a method in accordance with an embodiment of the present invention.

FIG. 18 is a flowchart representation of a method in accordance with an embodiment of the present invention.

### DETAILED DESCRIPTION OF THE INVENTION

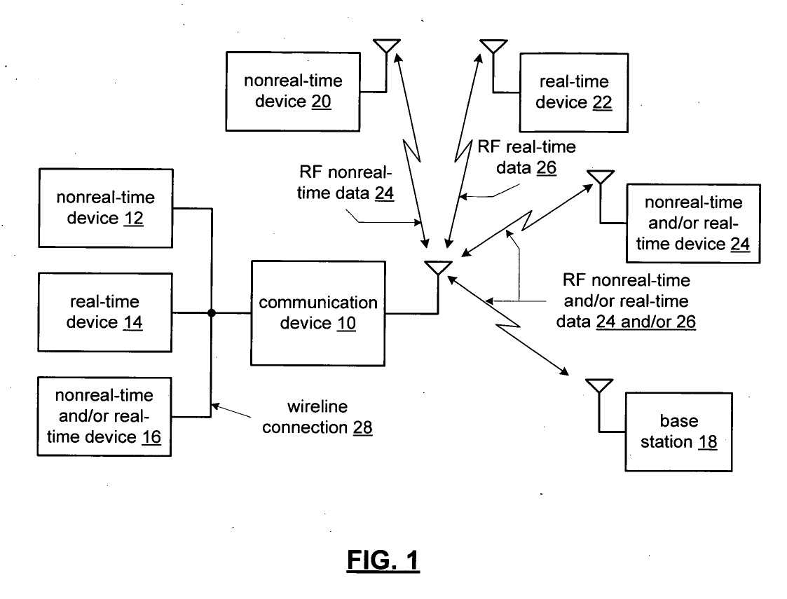

FIG. 1 is a schematic block diagram of an embodiment of a communication system in accordance with the present invention. In particular a communication system is shown that includes a communication device 10 that communicates real-time data 24 and/or non-real-time data 26 wirelessly with one or more other devices such as base station 18, non-real-time device 20, real-time device 22, and non-real-time and/or real-time device 24. In addition, communication device 10 can also optionally communicate over a wireline connection with non-real-time device 12, real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game console, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 24 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

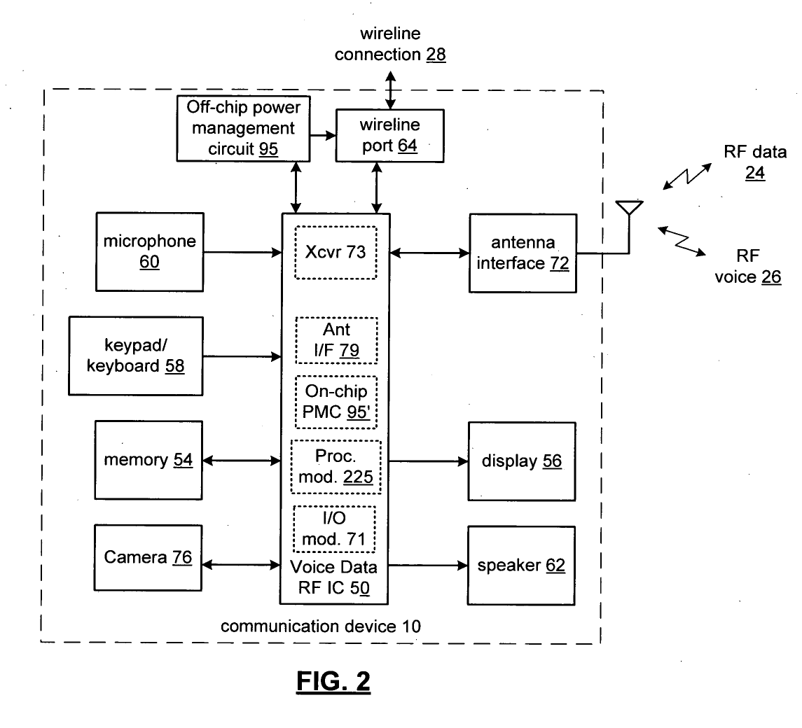

In an embodiment of the present invention, the communication device 10 includes an integrated circuit, such as a combined voice, data and RF integrated circuit that includes one or more features or functions of the present invention. Such integrated circuits shall be described in greater detail in association with FIGS. 2-18 that follow.

FIG. 2 is a schematic block diagram of an embodiment of an integrated circuit in accordance with the present invention. In particular, a voice data RF integrated circuit (IC) 50 is shown that implements communication device 10 in conjunction with microphone 60, keypad/keyboard 58, memory 54, speaker 62, display 56, camera 76, antenna interface 52 and wireline port 64. In addition, voice data RF IC 50 includes a transceiver 73 with RF and baseband modules for formatting and modulating data into RF real-time data 26 and non-real-time data 24 and transmitting this data via an antenna interface 72, optional on-chip antenna interface 79 and antenna. Further, voice data RF IC 50 includes an input/output module 71 with appropriate encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices.

Off-chip power management circuit 95 includes one or more DC-DC converters, voltage regulators, current regulators or other power supplies for supplying the voice data RF IC 50 and optionally the other components of communication device 10 and/or its peripheral devices with supply voltages and or currents (collectively power supply signals) that may be required to power these devices. Off-chip power management circuit 95 can operate from one or more batteries, line power and/or from other power sources, not shown. In particular, off-chip power management module can selectively supply power supply signals of different voltages, currents or current limits or with adjustable voltages, currents or current limits in response to power mode signals received from the voice data RF IC 50. Voice Data RF IC 50 optionally includes an on-chip power management circuit 95′ for replacing the off-chip power management circuit 95.

In an embodiment of the present invention, the voice data RF IC 50 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the voice, data and RF IC 50 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

In operation, the voice data RF IC 50 executes operational instructions that implement one or more of the applications (real-time or non-real-time) attributed to communication device 10 as discussed in conjunction with FIG. 1. Further, RF IC 50 operates to contemporaneously transmit and/or receive both non-realtime data and realtime data in accordance with the present invention, as will be discussed in greater detail in association with the description that follows.

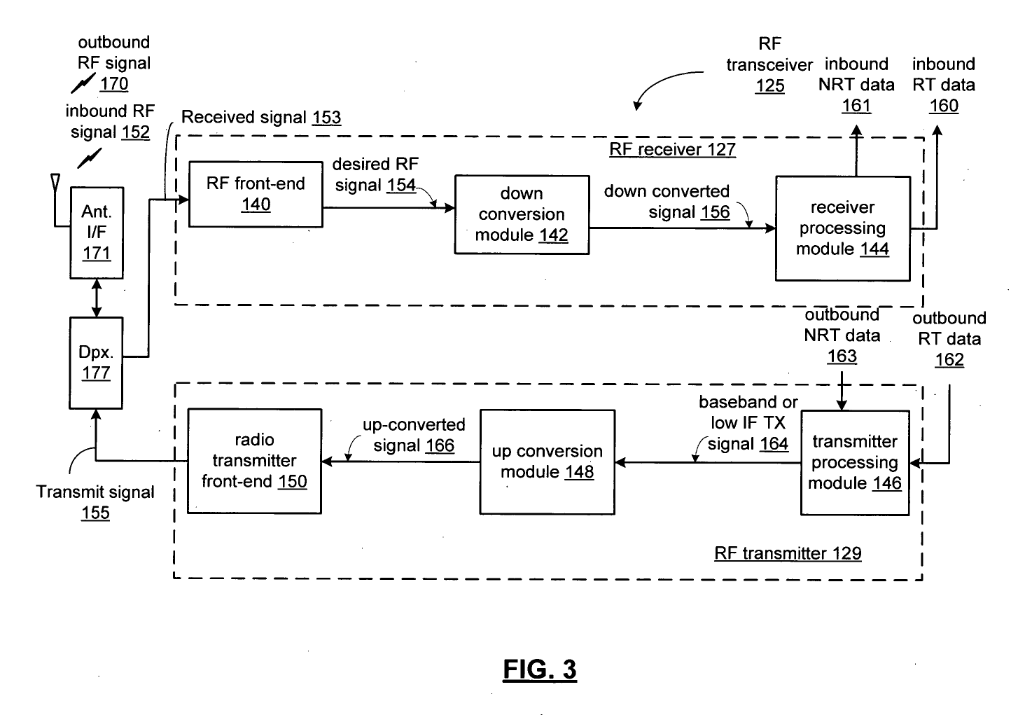

FIG. 3 is a schematic block diagram of an RF transceiver 125, such as transceiver 73, which may be incorporated in communication device 10. The RF transceiver 125 includes an RF transmitter 129, an RF receiver 127. The RF receiver 127 includes a RF front end 140, a down conversion module 142 and a receiver processing module 144. The RF transmitter 129 includes a transmitter processing module 146, an up conversion module 148, and a radio transmitter front-end 150.

As shown, the receiver and transmitter are each coupled to an antenna through an off-chip antenna interface 171 and a diplexer (duplexer) 177, that couples the transmit signal 155 to the antenna to produce outbound RF signal 170 and couples inbound signal 152 to produce received signal 153. While a single antenna is represented, the receiver and transmitter may share a multiple antenna structure that includes two or more antennas. In another embodiment, the receiver and transmitter may share a multiple input multiple output (MIMO) antenna structure that includes a plurality of antennas. Each of these antennas may be fixed, programmable, and antenna array or other antenna configuration. Also, the antenna structure of the wireless transceiver may depend on the particular standard(s) to which the wireless transceiver is compliant and the applications thereof.

In operation, the transmitter receives outbound realtime data 162 and outbound non-realtime data 163 from a host device, such as communication device 10 or other source via the transmitter processing module 146. The transmitter processing module 146 processes the outbound realtime data 162 and outbound non-realtime data 163 in accordance with a particular wireless communication standard (e.g., IEEE 802.11, Bluetooth, RFID, GSM, CDMA, et cetera) to produce baseband or low intermediate frequency (IF) transmit (TX) signals 164 that contain both outbound realtime data 162 and outbound non-realtime data 163. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 includes, but is not limited to, scrambling, encoding, puncturing, mapping, modulation, and/or digital baseband to IF conversion. Further embodiments of transmitter processing module 146 are described in conjunction with FIGS. 5-7.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up-converted signals 166 based on a transmitter local oscillation 168.

The radio transmitter front end 150 includes a power amplifier and may also include a transmit filter module. The power amplifier amplifies the up-converted signals 166 to produce outbound RF signals 170, which may be filtered by the transmitter filter module, if included. The antenna structure transmits the outbound RF signals 170 to a targeted device such as a RF tag, base station, an access point and/or another wireless communication device via an antenna interface 171 coupled to an antenna that provides impedance matching and optional bandpass filtration.

The receiver receives inbound RF signals 152 via the antenna and off-chip antenna interface 171 that operates to process the inbound RF signal 152 into received signal 153 for the receiver front-end 140. In general, antenna interface 171 provides impedance matching of antenna to the RF front-end 140 and optional bandpass filtration of the inbound RF signal 152. In an embodiment of the present invention, the inbound RF signal 152 contemporaneously carries both inbound real-time data 160 and inbound non-realtime data 161.

The down conversion module 70 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module.

The receiver processing module 144 processes the baseband or low IF signal 156 in accordance with a particular wireless communication standard (e.g., IEEE 802.11, Bluetooth, RFID, GSM, CDMA, et cetera) to produce inbound realtime data 160 and inbound non-realtime data 161. The processing performed by the receiver processing module 144 includes, but is not limited to, digital intermediate frequency to baseband conversion, demodulation, demapping, depuncturing, decoding, and/or descrambling. Further embodiments of receiver processing module 144 are presented in conjunction with FIGS. 8-10.

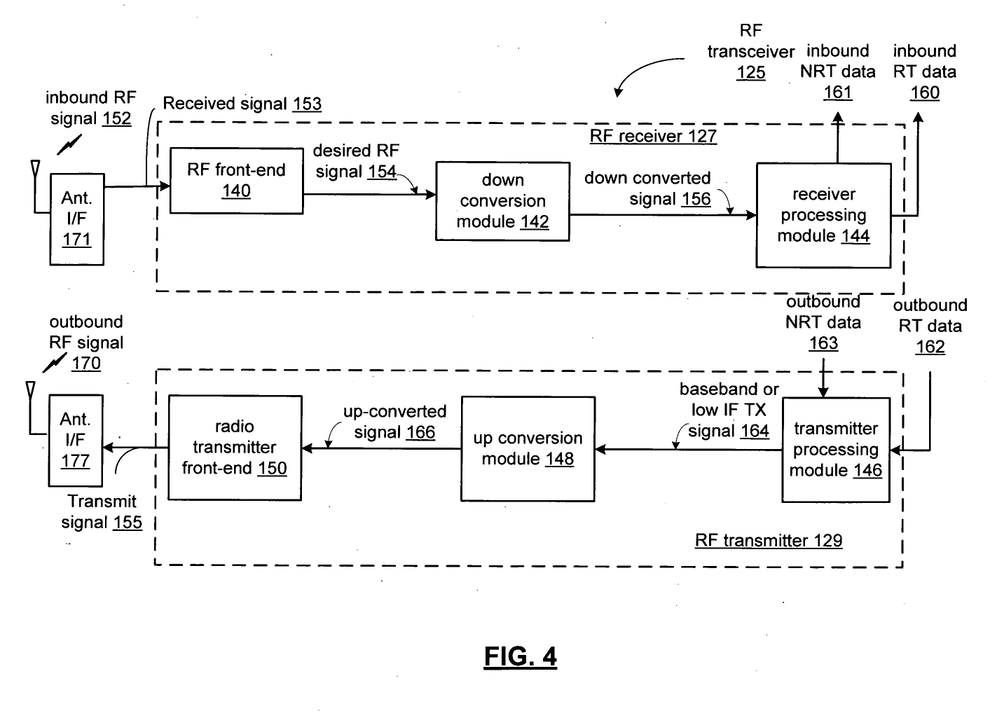

FIG. 4 is a schematic block diagram of an RF transceiver 125 in accordance with a further embodiment of the present invention. This embodiment is similar to the embodiment presented in conjunction with FIG. 3 with similar elements being referred to by common reference numerals. In this embodiment however, the RF receiver 127 receives inbound RF signals 152 via the antenna and off-chip antenna interface 171 and RF transmitter 129 generates transmit signal 155 to antenna interface 177 to produce outbound RF signal 170 via a separate antenna. As in the embodiment of FIG. 3, each of these separate antennas may be a single antenna or implemented using multiple antennas such as an antenna array, phased array or other multiple antenna structure.

FIG. 5 is a schematic block diagram of an embodiment of a transmitter processing module 200 in accordance with the present invention. In particular, a transmitter processing module 200, such as transmitter processing module 146 is shown for use in an RF transmitter, such as RF transmitter 129 that generates a transmit signal 155 that contemporaneously contains both outbound realtime data 162 and outbound non-realtime data 163. In operation, transmitter processing module 200 frequency division multiplexes the outbound realtime data 162 and the outbound non-realtime data 163 to form a frequency multiplexed signal that is included in baseband or low IF transmit signal 164.

In operation, transmitter processing module 200 upconverts outbound non-realtime data 163 to a higher frequency band by mixing the outbound non-realtime data 163 with oscillation 202 using mixer 204 and adding this upconverted signal using adder 206 to the outbound realtime data 162. This forms spectrum 208 that provides a guard band between the spectrum of outbound non-realtime data 163 and outbound realtime data 162. While shown at baseband, the transmitter processing module 200 could similarly produce a low intermediate frequency signal if further up conversion of the combined signal were included. Further while the outbound non-realtime data 163 is shown as being upconverted with respect to the outbound realtime data 162, in an alternative embodiment, the outbound realtime data 162 can be upconverted with respect to the outbound non-realtime data 163.

Note that the transmitter processing module 200 may perform additional functions and features such as scrambling, encoding, puncturing, mapping, modulation, and/or digital baseband to IF conversion and can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the transmitter processing module 200 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

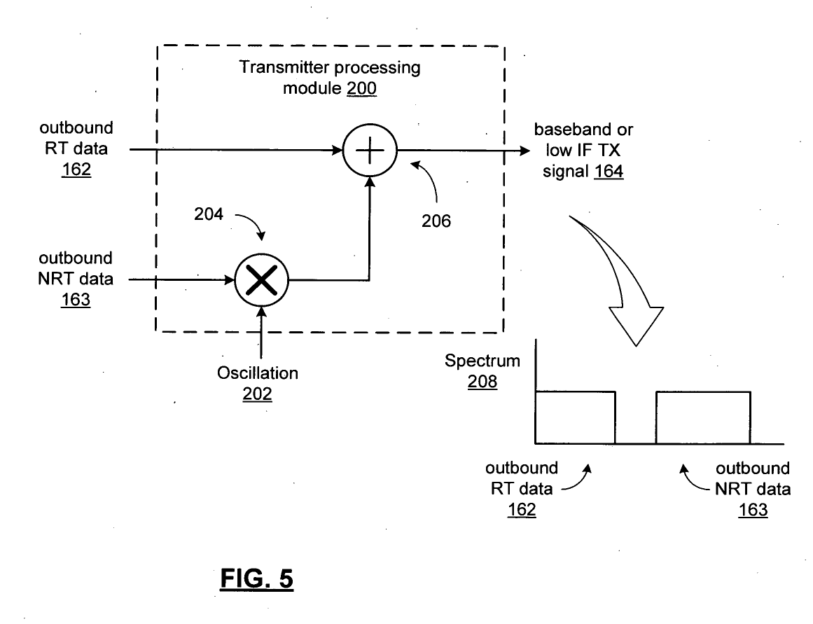

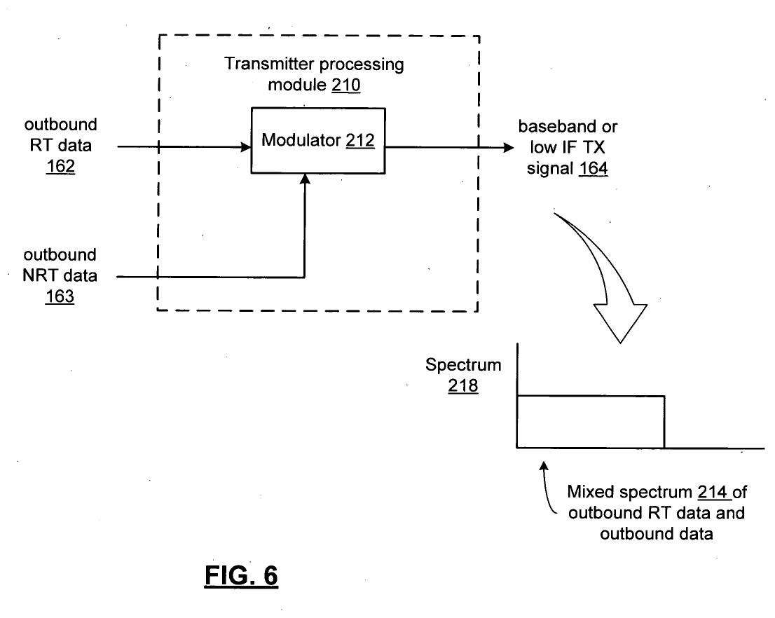

FIG. 6 is a schematic block diagram of an embodiment of a transmitter processing module 210 in accordance with the present invention. In particular, a transmitter processing module 210, such as transmitter processing module 146 is shown for use in an RF transmitter, such as RF transmitter 129 that generates a transmit signal 155 that contemporaneously contains both outbound realtime data 162 and outbound non-realtime data 163. In operation, transmitter processing module 200 modulates the outbound realtime data 162 and the outbound non-realtime data 163 to form a modulated signal that is included in baseband or low IF transmit signal 164.

In operation, modulator 212 includes an amplitude modulator, phase modulator, frequency modulator or other modulator that either modulates the outbound realtime data signal 162 with the outbound non-realtime data signal 163 or modulates the outbound non-realtime data signal 163 with the outbound realtime data signal 162. Alternatively, modulator 212 can include a polar modulator that creates a modulated signal by amplitude modulating by one of these two data signals (162, 163) and by phase or frequency modulating by the other of the two signals (162, 163). This forms spectrum 218 that includes a mixed spectrum 214 of outbound realtime data 162 and outbound non-realtime data 163. While shown at baseband, the transmitter processing module 210 could similarly produce a low intermediate frequency signal, if for instance, the modulator 212 frequency or phase modulates one of the signals to a low intermediate frequency and/or if up conversion of the modulated signal is included.

Note that the transmitter processing module 210 may perform additional functions and features such as scrambling, encoding, puncturing, mapping, modulation, and/or digital baseband to IF conversion and can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the transmitter processing module 210 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

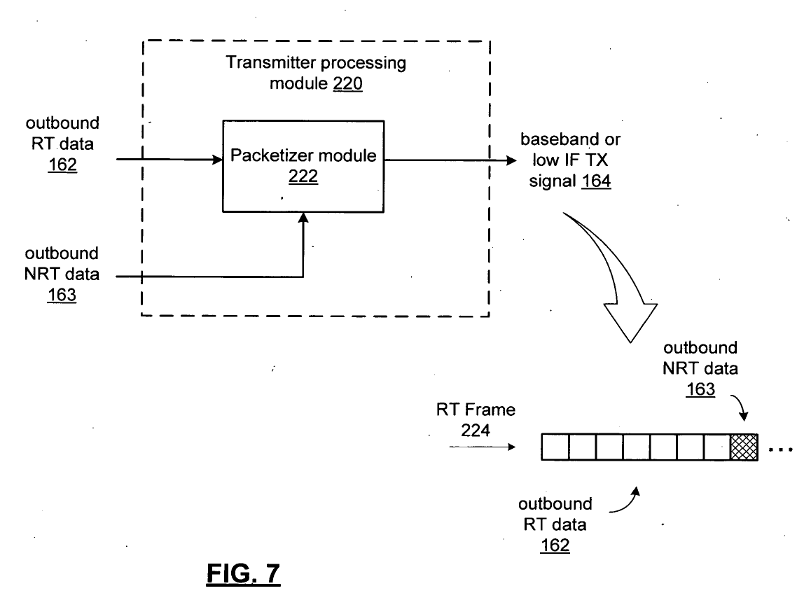

FIG. 7 is a schematic block diagram of an embodiment of a transmitter processing module 220 in accordance with the present invention. In particular, a transmitter processing module 220, such as transmitter processing module 146 is shown for use in an RF transmitter, such as RF transmitter 129 that generates a transmit signal 155 that contemporaneously contains both outbound realtime data 162 and outbound non-realtime data 163. In operation, transmitter processing module 200 inserts packets of outbound non-realtime data 163 into frames of outbound realtime data 162 to form a packetized signal that is included in baseband or low IF transmit signal 164.

In operation, packetizer module 222 packetizes outbound realtime data 162 into frames, such as realtime frames 224 that include packets of both outbound realtime data 162 and one or more packets of outbound non-realtime data 163. For instance, the outbound realtime data 162 can be voice data that is packetized in eight-packet GSM frames. One or more of these GSM packets in each frame can be reserved for packets of outbound non-realtime data 163. In this fashion, outbound realtime data 162 and outbound non-realtime data 163 can be contemporaneously transmitted in outbound RF signal 170 by including both outbound realtime data 162 and outbound non-realtime data 163 in each transmitted frame.

Note that the transmitter processing module 220 may perform additional functions and features such as scrambling, encoding, puncturing, mapping, modulation, and/or digital baseband to IF conversion and can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the transmitter processing module 220 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

FIG. 8 is a schematic block diagram of an embodiment of a receiver processing module 230 in accordance with the present invention. In particular, a receiver processing module 230, such as receiver processing module 144 is shown for use in an RF receiver, such as RF receiver 127 that contemporaneously generates both inbound realtime data 160 and inbound non-realtime data 161 from a received signal 153. In operation, receiver processing module 230 frequency demultiplexes the down converted signal 156 to generate the inbound realtime data 160 and the inbound non-realtime data 162.

Receiver processing module 230 receives a down converted signal 156 based on an inbound RF signal 152 from a remote device having a transmitter processing module that operates in a similar fashion to transmitter processing module 200, producing a spectrum such as the spectrum 208. In operation, receiver processing module 230 includes a filter module 232 that includes a filter circuit such as a low pass filter for passing the inbound realtime data 160, while filtering the upconverted inbound non-realtime data 161. In addition, the up converted inbound non-realtime data 161 is down converted by mixer 234 and oscillation 202 to produce the inbound non-realtime data 161. While a particular structure for receiver processing module 240 is shown, more generally, receiver processing module operates in a reciprocal fashion to the transmitter processing module of the remote transmitter to isolate the contemporaneously transmitted inbound realtime data 160 and inbound non-realtime data 161.

Note that the receiver processing module 230 may perform additional functions and features such as digital intermediate frequency to baseband conversion, demodulation, demapping, depuncturing, decoding, and/or descrambling and can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 230 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

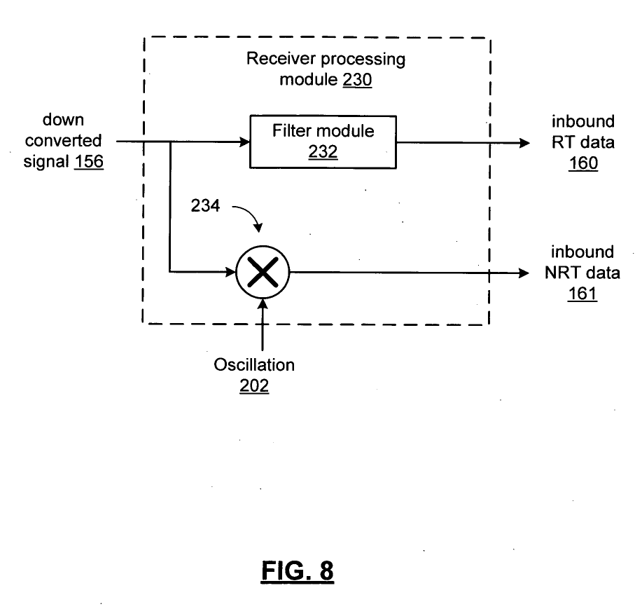

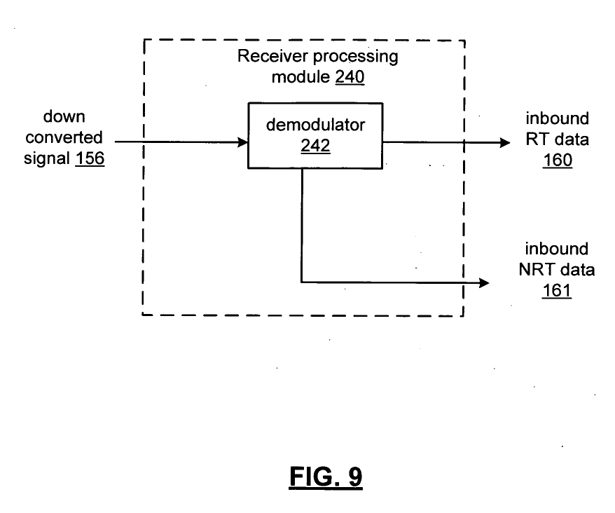

FIG. 9 is a schematic block diagram of an embodiment of a receiver processing module 240 in accordance with the present invention. In particular, a receiver processing module 240, such as receiver processing module 144 is shown for use in an RF receiver, such as RF receiver 127 that contemporaneously generates both inbound realtime data 160 and inbound non-realtime data 161 from a received signal 153. In operation, receiver processing module 240 demodulates the down converted signal 156 to generate the inbound realtime data 160 and the inbound non-realtime data 162.

Receiver processing module 240 receives a down converted signal 156 based on an inbound RF signal 152 from a remote device having a transmitter processing module that operates in a similar fashion to transmitter processing module 210, producing a spectrum such as the spectrum 218. Receiver processing module 240 includes a demodulator 242 that operates in a reciprocal fashion to the transmitter processing module of the remote transmitter to demodulate and isolate the contemporaneously transmitted inbound realtime data 160 and inbound non-realtime data 161.

Note that the receiver processing module 240 may perform additional functions and features such as digital intermediate frequency to baseband conversion, demodulation, demapping, depuncturing, decoding, and/or descrambling and can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 240 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

FIG. 10 is a schematic block diagram of an embodiment of a receiver processing module 250 in accordance with the present invention. In particular, a receiver processing module 250, such as receiver processing module 144 is shown for use in an RF receiver, such as RF receiver 127 that contemporaneously generates both inbound realtime data 160 and inbound non-realtime data 161 from a received signal 153. In operation, receiver processing module 250 depacketizes the down converted signal 156 to generate the inbound realtime data 160 and the inbound non-realtime data 162.

Receiver processing module 250 receives a down converted signal 156 based on an inbound RF signal 152 from a remote device having a transmitter processing module that operates in a similar fashion to transmitter processing module 210, producing packetized data such as realtime frames 224. Receiver processing module 250 includes a depacketizer module 252 that operates in a reciprocal fashion to the transmitter processing module of the remote transmitter to depacketize and isolate the contemporaneously transmitted inbound realtime data 160 and inbound non-realtime data 161.

Note that the receiver processing module 250 may perform additional functions and features such as digital intermediate frequency to baseband conversion, demodulation, demapping, depuncturing, decoding, and/or descrambling and can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 250 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

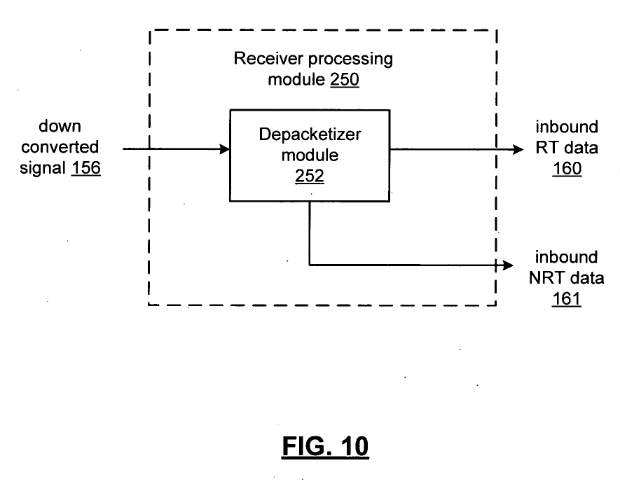

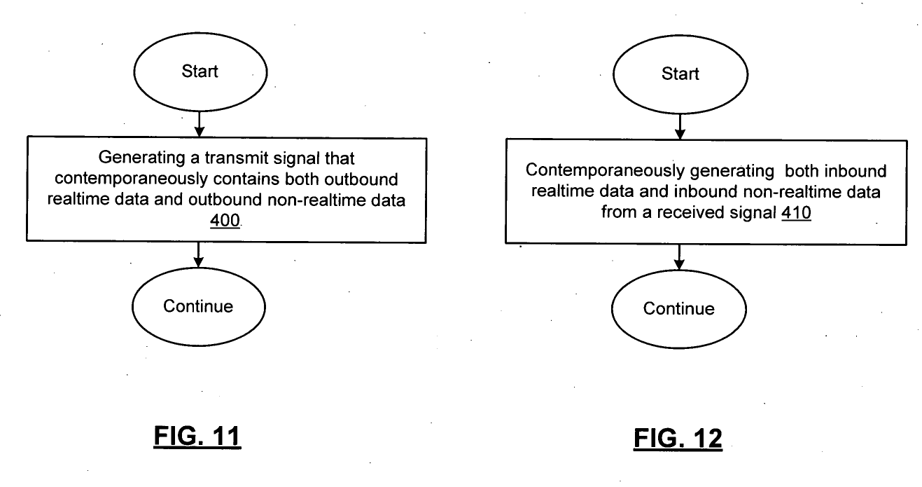

FIG. 11 is a flowchart representation of a method in accordance with an embodiment of the present invention. In particular a method is presented for use with one or more features or functions presented in conjunction with FIGS. 1-10. In step 400, a transmit signal is generated that contemporaneously contains both outbound realtime data and outbound non-realtime data. In an embodiment of the present invention, the outbound realtime data includes voice data.

FIG. 12 is a flowchart representation of a method in accordance with an embodiment of the present invention. In particular a method is presented for use with one or more features or functions presented in conjunction with FIGS. 1-11. In step 410, both inbound realtime data and inbound non-realtime data are contemporaneously generated from a received signal. In an embodiment of the present invention, the inbound realtime data includes voice data.

FIG. 13 is a flowchart representation of a method in accordance with an embodiment of the present invention. In particular a method is presented for use with one or more features or functions presented in conjunction with FIGS. 1-12. In step 420, the outbound realtime data and the outbound non-realtime data are frequency division multiplexed to form a frequency multiplexed signal. In step 422, the frequency multiplexed signal is up converted into an up-converted signal. In step 424, the transmit signal is generated based on the up-converted signal.

FIG. 14 is a flowchart representation of a method in accordance with an embodiment of the present invention. In particular a method is presented for use with one or more features or functions presented in conjunction with FIGS. 1-13. In step 430, the outbound realtime data is modulated with the outbound non-realtime data to form a modulated signal. In step 432, the modulated signal is upconverted into an up-converted signal. In step 434 the transmit signal is generated based on the up-converted signal.

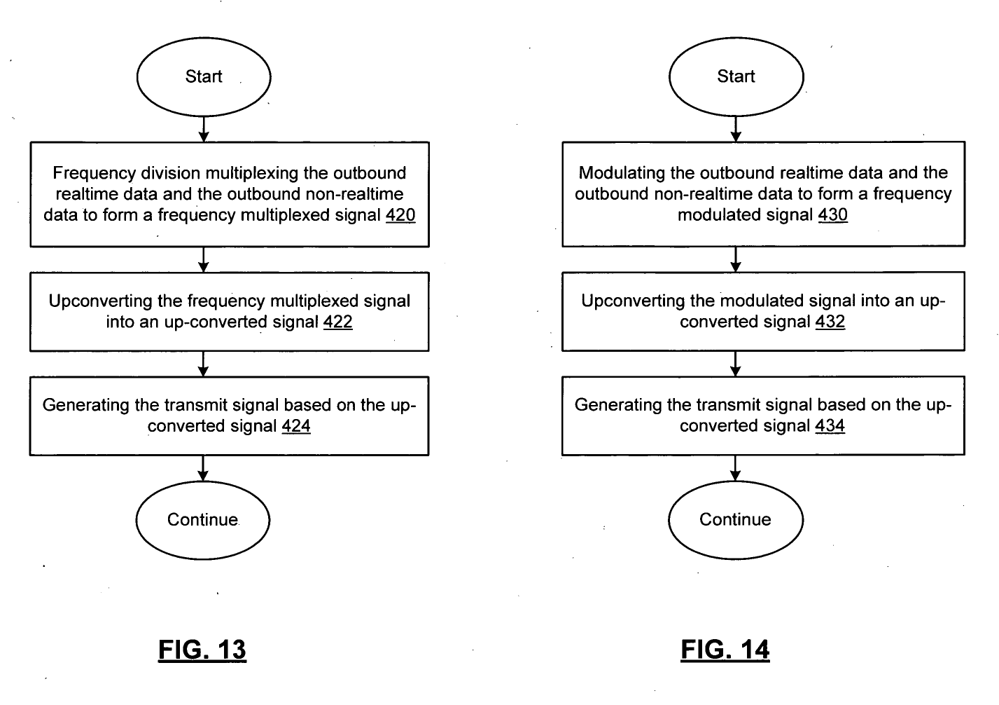

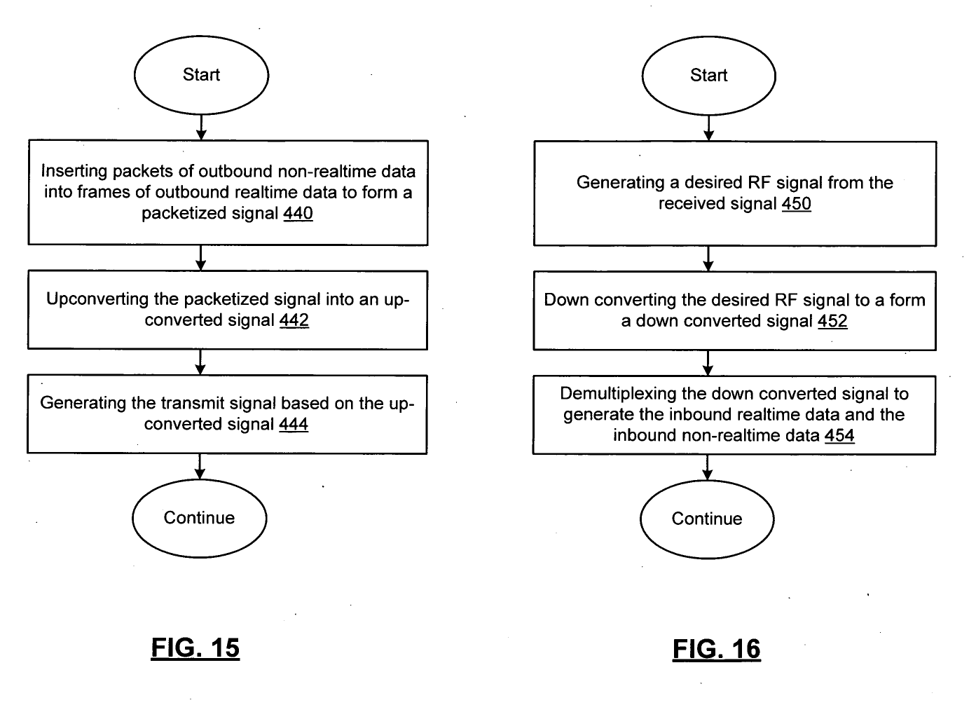

FIG. 15 is a flowchart representation of a method in accordance with an embodiment of the present invention. In particular a method is presented for use with one or more features or functions presented in conjunction with FIGS. 1-14. In step 440, packets of outbound non-realtime data are inserted into frames of outbound realtime data to form a packetized signal. In step 442, the packetized signal is upconverted into an up-converted signal. In step 444, the transmit signal is generated based on the up-converted signal.

FIG. 16 is a flowchart representation of a method in accordance with an embodiment of the present invention. In particular a method is presented for use with one or more features or functions presented in conjunction with FIGS. 1-15. In step 450, a desired RF signal is generated from the received signal. In step 452, the desired RF signal is down converted to form a down converted signal. In step 454, the down converted signal is demultiplexed to generate the inbound realtime data and the inbound non-realtime data.

FIG. 17 is a flowchart representation of a method in accordance with an embodiment of the present invention. In particular a method is presented for use with one or more features or functions presented in conjunction with FIGS. 1-16. In step 460, a desired RF signal is generated from the received signal. In step 462, the desired RF signal is down converted to form a down converted signal. In step 464, the down converted signal is demodulated to generate the inbound realtime data and the inbound non-realtime data.

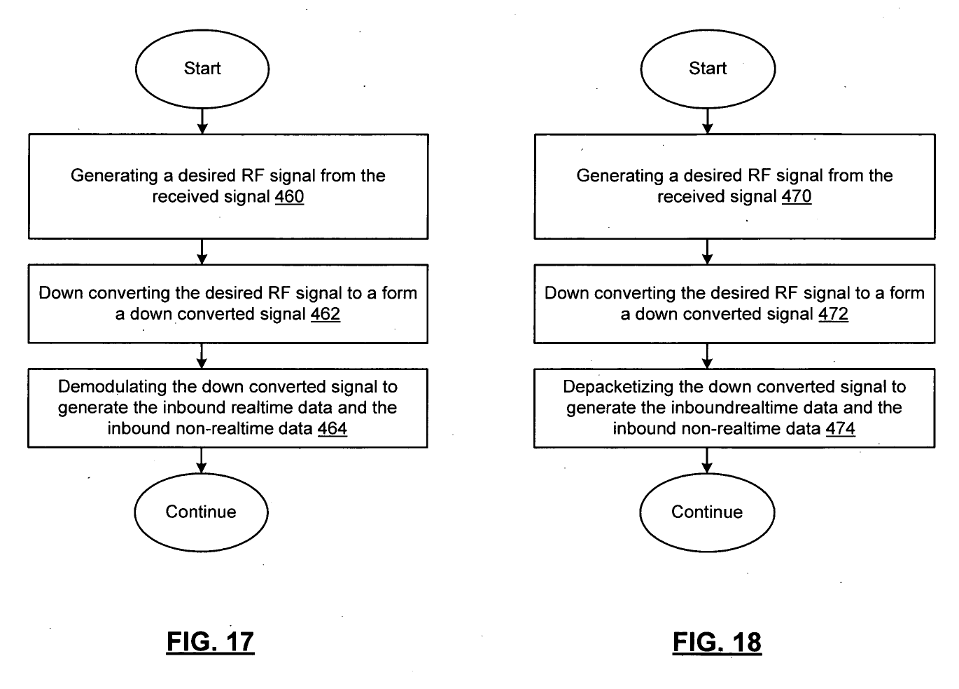

FIG. 18 is a flowchart representation of a method in accordance with an embodiment of the present invention. In particular a method is presented for use with one or more features or functions presented in conjunction with FIGS. 1-17. In step 470, a desired RF signal is generated from the received signal. In step 472, the desired RF signal is down converted to form a down converted signal. In step 474, the down converted signal is depacketized to generate the inbound realtime data and the inbound non-realtime data.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors discussed above may be field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A voice data and RF integrated circuit (IC) comprising:
an RF transmitter, that generates a transmit signal that contemporaneously contains both outbound realtime data and outbound non-realtime data.

2. The voice data and RF IC of claim 1 wherein the RF transmitter includes:
a transmitter processing module that frequency division multiplexes the outbound realtime data and the outbound non-realtime data to form a frequency multiplexed signal;
an up conversion module, coupled to the transmitter processing module, that upconverts the frequency multiplexed signal into an up-converted signal; and
a radio transmitter front-end, coupled to the up conversion module, that generates the transmit signal based on the up-converted signal.

3. The voice data and RF IC of claim 1 wherein the RF transmitter includes:
a transmitter processing module that modulates the outbound realtime data with the outbound non-realtime data to form a modulated signal;
an up conversion module, coupled to the transmitter processing module, that upconverts the modulated signal into an up-converted signal; and
a radio transmitter front-end, coupled to the up conversion module, that generates the transmit signal based on the up-converted signal.

4. The voice data and RF IC of claim 1 wherein the RF transmitter includes:
a transmitter processing module that inserts packets of outbound non-realtime data into frames of outbound realtime data to form a packetized signal;
an up conversion module, coupled to the transmitter processing module, that upconverts the packetized signal into an up-converted signal; and
a radio transmitter front-end, coupled to the up conversion module, that generates the transmit signal based on the up-converted signal.

5. The voice data and RF IC of claim 1 further comprising:
an RF receiver that contemporaneously generates both inbound realtime data and inbound non-realtime data from a received signal.

6. The voice data and RF IC of claim 5 wherein the RF receiver includes:
an RF front-end that generates a desired RF signal from the received signal;
a down conversion module, coupled to the RF front-end, that converts the desired RF signal to form a down converted signal; and
a receiver processing module that frequency demultiplexes the down converted signal to generate the inbound realtime data and the inbound non-realtime data.

7. The voice data and RF IC of claim 5 wherein the RF receiver includes:
an RF front-end that generates a desired RF signal from the received signal;
a down conversion module, coupled to the RF front-end, that converts the desired RF signal to form a down converted signal; and
a receiver processing module that demodulates the down converted signal to generate the inbound realtime data and the inbound non-realtime data.

8. The voice data and RF IC of claim 5 wherein the RF receiver includes:
an RF front-end that generates a desired RF signal from the received signal;
a down conversion module, coupled to the RF front-end, that converts the desired RF signal to form a down converted signal; and
a receiver processing module that depacketizes realtime data frames to generate the inbound realtime data and the inbound non-realtime data.

9. The voice data and RF IC of claim 1 wherein the outbound realtime data includes voice data.

10. A voice data and RF integrated circuit (IC) comprising:
an RF receiver that contemporaneously generates both inbound realtime data and inbound non-realtime data from a received signal.

11. The voice data and RF IC of claim 10 wherein the RF receiver includes:
an RF front-end that generates a desired RF signal from the received signal;
a down conversion module, coupled to the RF front-end, that converts the desired RF signal to form a down converted signal; and
a receiver processing module that frequency demultiplexes the down converted signal to generate the inbound realtime data and the inbound non-realtime data.

12. The voice data and RF IC of claim 10 wherein the RF receiver includes:
an RF front-end that generates a desired RF signal from the received signal;
a down conversion module, coupled to the RF front-end, that converts the desired RF signal to form a down converted signal; and
a receiver processing module that demodulates the down converted signal to generate the inbound realtime data and the inbound non-realtime data.

13. The voice data and RF IC of claim 10 wherein the RF receiver includes:
an RF front-end that generates a desired RF signal from the received signal;
a down conversion module, coupled to the RF front-end, that converts the desired RF signal to form a down converted signal; and
a receiver processing module that depacketizes realtime data frames to generate the inbound realtime data and the inbound non-realtime data.

14. The voice data and RF IC of claim 1 further comprising:
an RF transmitter, that generates a transmit signal that contemporaneously contains both outbound realtime data and outbound non-realtime data.

15. The voice data and RF IC of claim 14 wherein the RF transmitter includes:
a transmitter processing module that frequency division multiplexes the outbound realtime data and the outbound non-realtime data to form a frequency multiplexed signal;
an up conversion module, coupled to the transmitter processing module, that upconverts the frequency multiplexed signal into an up-converted signal; and
a radio transmitter front-end, coupled to the up conversion module, that generates the transmit signal based on the up-converted signal.

16. The voice data and RF IC of claim 14 wherein the RF transmitter includes:
a transmitter processing module that modulates the outbound realtime data with the outbound non-realtime data to form a modulated signal;
an up conversion module, coupled to the transmitter processing module, that upconverts the modulated signal into an up-converted signal; and
a radio transmitter front-end, coupled to the up conversion module, that generates the transmit signal based on the up-converted signal.

17. The voice data and RF IC of claim 14 wherein the RF transmitter includes:
a transmitter processing module that inserts packets of outbound non-realtime data into frames of outbound realtime data to form a packetized signal;
an up conversion module, coupled to the transmitter processing module, that upconverts the packetized signal into an up-converted signal; and
a radio transmitter front-end, coupled to the up conversion module, that generates the transmit signal based on the up-converted signal.

18. The voice data and RF IC of claim 10 wherein the inbound realtime data includes voice data.

19. A method for use in a voice data and RF integrated circuit (IC), the method comprising:
generating a transmit signal that contemporaneously contains both outbound realtime data and outbound non-realtime data.

20. The method of claim 19 wherein the step of transmitting includes:
frequency division multiplexing the outbound realtime data and the outbound non-realtime data to form a frequency multiplexed signal;
upconverting the frequency multiplexed signal into an up-converted signal; and
generating the transmit signal based on the up-converted signal.

21. The method of claim 19 wherein the step of transmitting includes:
modulating the outbound realtime data with the outbound non-realtime data to form a modulated signal;
upconverting the modulated signal into an up-converted signal; and
generating the transmit signal based on the up-converted signal.

22. The method of claim 19 wherein the step of transmitting includes:
inserting packets of outbound non-realtime data into frames of outbound realtime data to form a packetized signal;
upconverting the packetized signal into an up-converted signal; and
generating the transmit signal based on the up-converted signal.

23. The method of claim 19 further comprising:
contemporaneously generating both inbound realtime data and inbound non-realtime data from a received signal.

24. The method of claim 23 wherein the step of contemporaneously generating includes:
generating a desired RF signal from the received signal;
down converting the desired RF signal to form a down converted signal; and
demultiplexing the down converted signal to generate the inbound realtime data and the inbound non-realtime data.

25. The method of claim 23 wherein the step of contemporaneously generating includes:
generating a desired RF signal from the received signal;
down converting the desired RF signal to form a down converted signal; and
demodulating the down converted signal to generate the inbound realtime data and the inbound non-realtime data.

26. The method of claim 23 wherein the step of contemporaneously generating includes:
generating a desired RF signal from the received signal;
down converting the desired RF signal to form a down converted signal; and
depacketizing realtime data frames to generate the inbound realtime data and the inbound non-realtime data.

27. The method of claim 23 wherein the outbound realtime data includes voice data.
